(19) United States
(12) Patent Application Publication
(10) Pub. No.: US 2017/0227901 A1
(43) Pub. Date: Aug. 10, 2017

(54) IMAGE HEATING DEVICE

(71) Applicant: CANON KABUSHIKI KAISHA, Tokyo (JP)

(72) Inventors: Rikiya Takemasa, Kashiwa-shi (JP); Hidekazu Maruta, Abiko-shi (JP); Masayuki Tamaki, Abiko-shi (JP); Ryo Suzuki, Kashiwa-shi (JP); Mitsuru Hasegawa, Tsukubamirai-shi (JP); Ryo Yashiro, Tokyo (JP); Koichi Kakubari, Kashiwa-shi (JP); Shigeru Hirano, Tokyo (JP)

(21) Appl. No.: 15/499,650

(22) Filed: Apr. 27, 2017

Related U.S. Application Data
(63) Continuation of application No. PCT/JP2015/078985, filed on Oct. 14, 2015.

(30) Foreign Application Priority Data
Oct. 30, 2014 (JP) 2014-221979

(51) Int. Cl. G03G 15/20

(52) U.S. Cl. CPC G03G 15/2053

(57) ABSTRACT

An image heating device includes a fixing belt (100) including a heat generating layer (102); a pressure roller (110) configured to rotationally drive the fixing belt; a power feed ring (119) disposed at one end of the fixing belt in a longitudinal direction and extending along an outer periphery of the fixing belt, the power feed ring being electrically connected to the heat generating layer; a brush (81) configured to be brought into contact with an outer periphery of the power feed ring and electrically connected to the power feed ring; a power supply circuit (79) configured to feed power to the brush; and a leaf spring (82) configured to elastically press the brush toward the power feed ring, the leaf spring being configured to come into contact with the power feed ring when the brush wears by a predetermined amount.

### CROSS-REFERENCE TO RELATED APPLICATIONS

This application is a Continuation of International Patent Application No. PCT/JP2015/078985, filed Oct. 14, 2015, which claims the benefit of Japanese Patent Application No. 2014-221979, filed Oct. 30, 2014, both of which are hereby incorporated by reference herein in their entirety.

### TECHNICAL FIELD

The present invention relates to an image heating device configured to fix an image onto a sheet. The image heating device can be used in image forming apparatuses, such as copiers, printers, facsimile machines, and multifunction peripherals combining some of these functions.

### BACKGROUND ART

In an image forming apparatus, such as an electrophotographic apparatus or an electrostatic recording apparatus, a toner image is formed on a sheet and a fixing device (image heating device) applies heat and pressure to the toner image to fix it to the sheet. PTL 1 proposes a fixing device that uses a fixing belt including a resistive heat generating layer configured to generate heat when energized. The fixing device having this configuration can achieve high energy-saving performance, because heat generated by the fixing belt can be efficiently supplied to an image on a sheet.

In the fixing device described in PTL 1, electrode layers electrically connected to the resistive heat generating layer are located at respective ends of the fixing belt, so that electric current is supplied from the electrode layers to the fixing belt. Specifically, by bringing power feed members connected to a power supply into slidably contact with the electrode layers, electric current is supplied to the fixing belt which is running. The power feed members each include a brush formed by a conductive carbon chip or the like, and a leaf spring configured to press the brush against the outer surface of the corresponding electrode layer.

### CITATION LIST

### Patent Literature

PTL 1 Japanese Patent Laid-Open No. 2011-253085

The brush is gradually worn by sliding against the electrode layer. When the brush wears, the deflection of the leaf spring decreases and the force of pressing the brush against the electrode layer decreases. As the brush wears, the leaf spring may return to a natural state where it does not deflect. In this case, the brush is isolated from the electrode layer and this leads to a failure in feeding power to the belt. If power cannot be properly fed to the belt, the fixing device fails to properly heat the belt and this causes a failure in forming a high-quality image.

It is thus preferable that the leaf spring used in the fixing device be configured to press the brush toward the electrode layer even when the brush is in an advanced stage of wear.

An object of the present invention is to provide an image heating device in which the occurrence of a failure in feeding power to the belt can be reduced.

### SUMMARY OF INVENTION

An image heating device according to an aspect of the present invention includes an endless belt including a heat generating layer that generates heat when energized, the belt being configured to heat an image on a sheet; a driving unit configured to rotationally drive the belt; a first ring-shaped member disposed at one end of the belt in a longitudinal direction and extending along an outer periphery of the belt, the first ring-shaped member being electrically connected to the heat generating layer; a first contact pad configured to be brought into contact with an outer periphery of the first ring-shaped member and electrically connected to the first ring-shaped member; a power supply unit configured to feed power to the first contact pad; and a first pressing member disposed to face the first ring-shaped member with the first contact pad interposed therebetween, the first pressing member being configured to elastically press the first contact pad toward the first ring-shaped member regardless of the amount of wear of the first contact pad.

Further features of the present invention will become apparent from the following description of exemplary embodiments with reference to the attached drawings.

### BRIEF DESCRIPTION OF DRAWINGS

FIG. 1 illustrates an image forming apparatus using a fixing device according to an example.

FIG. 2 is a cross-sectional view taken along a short side of the fixing device according to the example.

FIG. 3 is a cross-sectional view taken along a long side of the fixing device according to the example.

FIG. 4 illustrates a configuration of end portions of a fixing belt according to the example.

FIG. 5 illustrates a configuration of an electrode unit according to the example.

FIG. 6 illustrates a configuration of a power feeder in an early endurance stage according to the example.

FIG. 7 illustrates a configuration of the power feeder in a late endurance stage according to the example.

FIG. 8 illustrates a configuration of a power feeder according to another example.

FIG. 9 illustrates a configuration of a power feeder according to still another example.

### DESCRIPTION OF EMBODIMENTS

Embodiments of the present invention will now be described in detail by examples. In the following examples, a laser beam printer using an electrophotographic process will be described as an image forming apparatus. In the following description, the laser beam printer will be referred to as a printer 1.

### EXAMPLES

[Image Forming Unit]

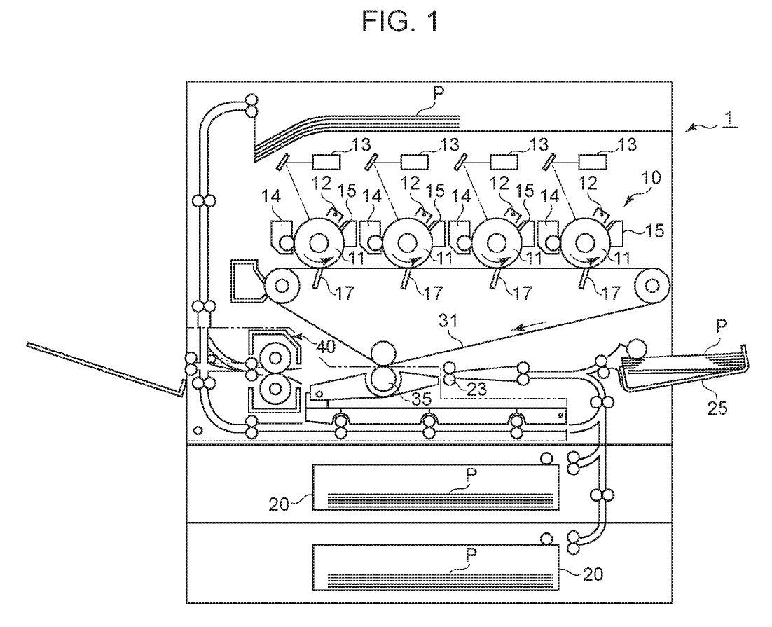

FIG. 1 is a cross-sectional view of the printer 1. The printer 1 is an image forming apparatus in which a toner image T formed on each photosensitive drum 11 in an image forming unit (image forming station) 10 is transferred onto a sheet P and fixed to the sheet P by a fixing device 40, so as to form an image on the sheet P. The configuration of the printer 1 will now be described in detail using FIG. 1.

As illustrated in FIG. 1, the printer 1 includes the image forming unit 10 for forming toner images of yellow (Y), magenta (M), cyan (C), and black (Bk) colors. The image forming unit 10 includes four photosensitive drums 11 (11Y, 11M, 11C, and 11Bk) corresponding to Y, M, C, and Bk, respectively, in this order from the left side in FIG. 1. The following components are arranged around each of the photosensitive drums 11 in the same manner: a charger 12 (12Y, 12M, 12C, or 12Bk), an exposure device 13 (13Y, 13M, 13C, or 13Bk), a developing device 14 (14Y, 14M, 14C, or 14Bk), a primary transfer blade 17 (17Y, 17M, 17C, or 17Bk), and a cleaner 15 (15Y, 15M, 15C, or 15Bk). Hereinafter, a configuration for forming a Bk toner image will be described as a representative example. The description of components corresponding to the other colors will be omitted by using the same reference numerals. That is, when no distinction is needed, the components described above will be simply referred to as the photosensitive drum 11, charger 12, exposure device 13, developing device 14, primary transfer blade 17, and cleaner 15.

The photosensitive drum 11, which is an electrophotographic photosensitive member, is rotationally driven by a driving source (not shown) in the direction of arrow (counterclockwise in FIG. 1). The charger 12, the exposure device 13, the developing device 14, the primary transfer blade 17, and the cleaner 15 are arranged around the photosensitive drum 11 in this order along the direction of rotation of the photosensitive drum 11.

The surface of the photosensitive drum 11 is charged in advance by the charger 12. Then, the photosensitive drum 11 is exposed to light by the exposure device 13 configured to emit a laser beam in accordance with image information, whereby an electrostatic latent image is formed on the photosensitive drum 11. The electrostatic latent image is turned into a toner image of Bk color by the developing device 14. The same process is performed for the other colors. The toner images on the respective photosensitive drums 11 are sequentially primary-transferred by the primary transfer blades 17 onto an intermediate transfer belt 31. After the primary transfer, the residual toner on each photosensitive drum 11 is removed by the cleaner 15. The surface of the photosensitive drum 11 is thus cleaned and becomes ready for the next image formation.

The sheets P loaded on a paper cassette 20 or multi-paper tray 25 are sent out one by one by a paper feed mechanism (not shown) and fed into a registration roller pair 23. The sheets P are each a member having a surface on which an image is formed. Examples of the sheet P include plain paper, cardboard, resin sheet member, and overhead projector film. The registration roller pair 23 temporarily stops conveying the sheet P. If the sheet P is skewed with respect to the conveyance direction, the registration roller pair 23 straightens the sheet P. Then, in synchronization with a color toner image on the intermediate transfer belt 31, the registration roller pair 23 feeds the sheet P into the space between the intermediate transfer belt 31 and a secondary transfer roller 35. The secondary transfer roller 35 transfers the color toner image on the intermediate transfer belt 31 to the sheet P. In the present example, an image is formed in this manner. The sheet P is then fed toward the fixing device 40, which applies heat and pressure to the toner image T on the sheet P to fix the toner image T to the sheet P.

[Fixing Device]

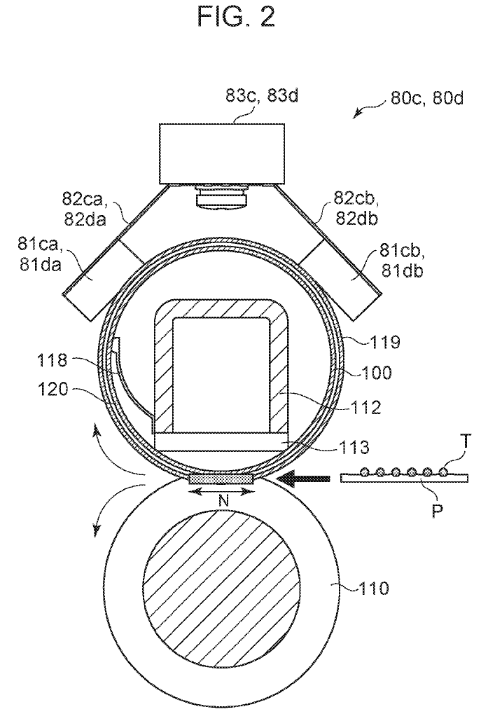

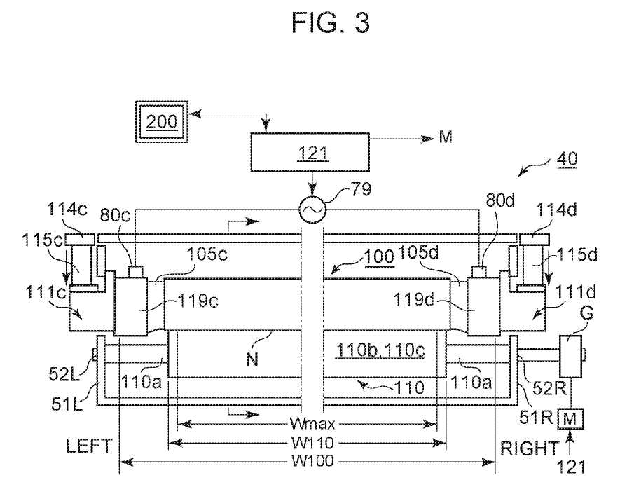

The fixing device 40 serving as an image heating device in the printer 1 will now be described. FIG. 2 is a cross-sectional view taken along a short side of the fixing device 40. FIG. 3 is a cross-sectional view taken along a long side of the fixing device 40. For the fixing device 40 or its components, a front side refers to a side as viewed from a sheet entry side of the fixing device 40 (see FIG. 3), and a back side refers to a side (sheet exit side) opposite the front side. The right and left refer to a right side of the fixing device 40 as viewed from the front side (right side in FIG. 3, back side in FIG. 2), and a left side of the fixing device 40 as viewed from the front side (left side in FIG. 3, front side in FIG. 2). Upstream and downstream sides refer to upstream and downstream sides with respect to the sheet conveyance direction. A long-side (longitudinal) direction or sheet width direction refers to a direction substantially parallel to the direction (right-left direction in FIG. 3) orthogonal to the conveyance direction of the sheet P on the surface of the sheet conveyance path. A short-side direction refers to a direction substantially parallel to the conveyance direction of the sheet P (right-left direction in FIG. 2) on the surface of the sheet conveyance path.

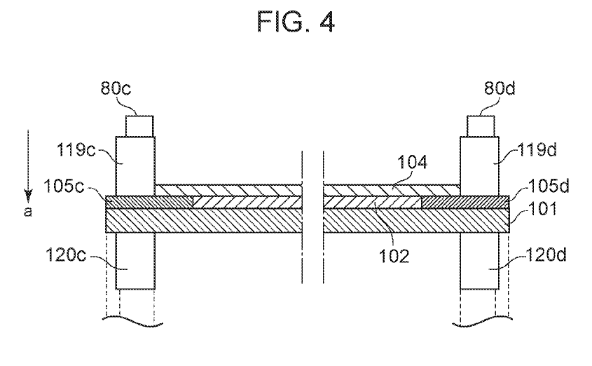

The fixing device 40 is an image heating device that uses a fixing belt 100 (hereinafter referred to as the belt 100) including a resistive heat generating layer 102 (see FIG. 4, hereinafter referred to as the heat generating layer 102) configured to generate heat when energized. The fixing device 40 can achieve high energy-saving performance, because heat generated by the belt 100 when it is energized can be efficiently supplied to the image T on the sheet P.

As illustrated in FIG. 2, a nip portion N is formed when the belt 100 is sandwiched between a nip pad 113 and a pressure roller 110 (hereinafter referred to as the roller 110). Then, the sheet P fed to the nip portion N is conveyed while being sandwiched between the belt 100 running in the direction of arrow (clockwise in FIG. 2) and the roller 110 rotating in the direction of arrow (counterclockwise in FIG. 2). Since the belt 100 generates heat by power fed from a power feeder 80, an unfixed toner image T on the sheet P is applied with heat and pressure and fixed to the sheet P. In the present example, a fixing process is performed as described above. A configuration of the fixing device 40 will now be described in detail using drawings.

The belt 100 is a cylindrical or endless belt (film) configured to generate heat by Joule heating, which involves passage of electric current therethrough, thereby heating an image on the sheet P at the nip portion N. In the present example, a length W100 (see FIG. 3) of the belt 100 in the width direction (longitudinal direction) is 340 mm, and the diameter of the belt 100 is 24 mm. As illustrated in FIG. 3, a power feed ring 119c and a power feed ring 119d are attached to a left end portion and a right end portion, respectively, of the belt 100 in the longitudinal direction. A power feeder 80c is electrically connected through the power feed ring 119c to the belt 100, and a power feeder 80d is electrically connected through the power feed ring 119d to the belt 100, whereby power is fed to the belt 100. Hereinafter, when no distinction is needed, the power feed rings 119c and 119d will each be referred to as the ring 119, and the power feeders 80c and 80d will each be referred to as the power feeder 80. The belt 100, the ring 119, and the power feeder 80 will be described in detail later on.

The nip pad 113 serves as a pressing member that presses the belt 100 from the inner surface side of the belt 100 toward the roller 110. The longitudinal direction of the nip pad 113 corresponds to the front-back direction in FIG. 2, and the length of the nip pad 113 is the same as a length W110 (see FIG. 3) of the roller 110.

A support stay 112 is a support member that supports the nip pad 113. The support stay 112 is preferably made of a material that is not easily deflected by application of high pressure thereto. In the present example, stainless steel (SUS304) is used to form the support stay 112. The support stay 112 is supported by flanges 111c and 111d at the left and right ends thereof, respectively, in the longitudinal direction. The flanges 111c and 111d are regulating members configured to regulate the movement of the belt 100 in the longitudinal direction, and the shape of the belt 100 in the circumferential direction.

In the fixing device 40, as illustrated in FIG. 3, a pressure spring 115c is loaded between the flange 111c and a pressure arm 114c. Similarly, a pressure spring 115d is loaded between the flange 111d and a pressure arm 114d. Thus, by means of the flanges 111c and 111d, the support stay 112, and the nip pad 113, the belt 100 is pressed with a predetermined pressing force against the upper surface of the roller 110 to form the nip portion N having a predetermined width. In the present example, a pressure applied to the roller 110 is 156.8 N (16 kgf) at one end, and the total pressure applied to the roller 110 is 313.6 N (32 kgf).

The roller 110 serving as a driving unit comes into contact with the belt 100 to form the nip portion N in cooperation with the belt 100. The roller 110 is a multilayer member formed by stacking a 3-mm-thick conductive elastic layer 110b and a 50-μm-thick toner parting layer 110c in this order on a stainless core metal 110a with a diameter of 18 mm. The core metal 110a, the elastic layer 110b, and the toner parting layer 110c are firmly bonded by an adhesive made of silicone resin.

In the present example, the length W110 of a region where the core metal 110a of the roller 110 has the elastic layer 110b and the toner parting layer 110c thereon is 320 mm. This corresponds to the length of a heat generating region of the belt 100. The fixing device 40 can thus perform a fixing process on sheets P of up to a maximum width Wmax (A3 size in the present example).

The core metal 110a is rotatably held between a front side plate 51L and a back side plate 51R by bearing members 52L and 52R. A gear G is attached to one end of the core metal 110a in the longitudinal direction, so that the drive of a motor M is transmitted to the roller 110. The roller 110 is thus rotationally driven at a predetermined circumferential speed in the direction of arrow (counterclockwise in FIG. 2). Since the belt 100 is in press-contact with the roller 110, the belt 100 is driven to run by the drive transmitted from the roller 110.

Grease is applied to the inner surface of the belt 100. This reduces friction between the nip pad 113 and the inner surface of the belt 100.

A thermistor 118 (see FIG. 2) is a sensor that detects the temperature of the belt 100. In the present example, the thermistor 118 is attached to the tip of a stainless arm extending from the support stay 112 to elastically come into contact with the inner surface of the belt 100. A polyimide tape is wound around the thermistor 118 to maintain insulation from the belt 100.

As illustrated in FIG. 3, a power supply circuit 79 is a circuit that supplies power through the power feeders 80 to the belt 100. The power supply circuit 79 is electrically connected to each of the power feeders 80c and 80d. During power feeding, the power supply circuit 79 applies an effective alternating-current voltage of about 100 (V) between the power feeders 80c and 80d. The power supply circuit 79 may apply a constant voltage (direct-current voltage) to the heat generating layer 102. However, for efficient heat generation in the heat generating layer 102, it is preferable to apply an alternating-current voltage to the heat generating layer 102.

A control circuit 121 is a circuit including a central processing unit (CPU) that performs computations associated with various control operations, and a nonvolatile medium, such as a read-only memory (ROM), that stores various programs. The CPU reads out and executes the programs stored in the ROM, thereby executing various control operations. The control circuit 121 may be an integrated circuit, such as an application-specific integrated circuit (ASIC), that performs the same functions as above. The control circuit 121 is electrically connected to the thermistor 118 to acquire temperature information detected by the thermistor 118.

The control circuit 121 is electrically connected to the motor M to control the drive of the motor M. The control circuit 121 is electrically connected to the power supply circuit 79 to control the application of electric current from the power supply circuit 79 to the belt 100.

With the configuration described above, the control circuit 121 controls the application of electric current from the power supply circuit 79 to the belt 100 in accordance with the temperature detected by the thermistor 118. That is, the control circuit 121 controls the heat generation of the belt 100 such that the belt 100 is heated to a predetermined temperature. Specifically, the control circuit 121 performs the following control operations.

For example, upon receipt of a fixing operation start signal transmitted from an external information terminal 200, the control circuit 121 activates the power supply circuit 79 to start supplying power to the power feeders 80. The power supply circuit 79 continues to supply power to the power feeders 80 until the temperature detected by the thermistor 118 on the inner surface of the belt 100 reaches a predetermined target temperature U1 (160° C. in the present example). When the temperature detected by the thermistor 118 reaches the target temperature U1, the control circuit 121 drives the motor M. By driving the motor M, the roller 110 is rotationally driven and the belt 100 is driven to run accordingly. When the power supply circuit 79 further continues to supply power to the power feeders 80 and the temperature detected by the thermistor 118 reaches a target temperature U2 (165° C. in the present example), the control circuit 121 introduces the sheet P carrying an unfixed toner image T into the nip portion N. The control circuit 121 thus controls the fixing process performed on the sheet P by the fixing device 40. When the fixing device 40 continues to perform the fixing process on another sheet P, the control circuit 121 controls power supplied from the power supply circuit 79 in accordance with the temperature detected by the thermistor 118, thereby stabilizing the temperature of the belt 100 at around the target temperature U2. In the present example, the power supplied from the power supply circuit 79 is regulated by wave-number control. When conditions for ending the fixing operation are met, the control circuit 121 causes the power supply circuit 79 to stop supplying power to the belt 100 and stops driving the motor M.

[Fixing Belt]

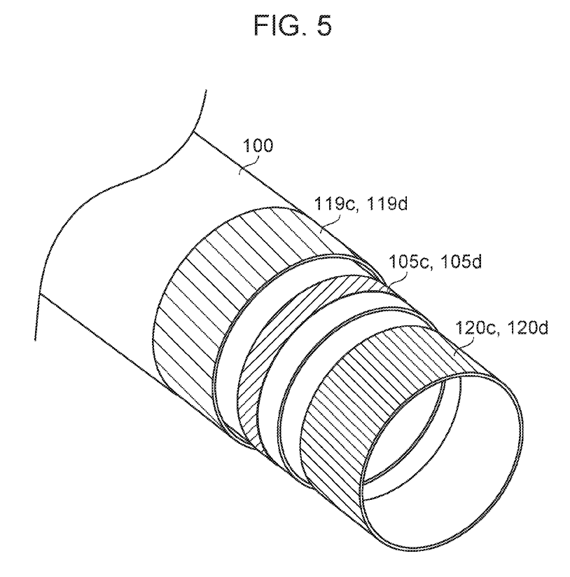

A configuration of the belt 100 will now be described in detail. FIG. 4 illustrates a layer structure of the belt 100. The direction of arrow “a” in FIG. 4 is toward the inside of the belt 100. FIG. 5 illustrates a configuration of an electrode unit. The belt 100 of the present example has a three-layer composite structure composed of a base layer 101, the heat generating layer 102, and a toner parting layer 104 in this order from the inside to the outside. An electrode layer 105c and an electrode layer 105d at the left and right ends, respectively, in the longitudinal direction of the belt 100 are disposed on the base layer 101 and extend along the entire circumference of the belt 100. To stabilize the electrical connection between the belt 100 and the power feeders 80 (described below) in the present example, the fixing device 40 is configured in the following manner. That is, in the longitudinal direction of the belt 100, the ring 119c and a backup member 120c are attached to the left end portion, and the ring 119d and a backup member 120d are attached to the right end portion. Hereinafter, when no distinction is needed, the electrode layers 105c and 105d will each be referred to as the electrode layer 105, and the backup members 120c and 120d will each be referred to as the backup member 120. To allow the belt 100 to easily follow the surface irregularities of the sheet P, an elastic layer made of rubber or the like may be provided between the toner parting layer 104 and the heat generating layer 102. The belt 100 will now be described in detail using drawings.

The base layer 101 is a layer that serves as a base of the belt 100 and maintains the strength of the belt 100. At the same time, the base layer 101 is a flexible member deformable in the circumferential direction. A resin belt made of a heat resistant material, such as polyimide, polyimidoamide, polyether ether ketone (PEEK), polytetrafluoroethylene (PTFE), perfluoroalkoxy alkane (PFA), or perfluoroethylene propylene copolymer (FEP), may be used as the base layer 101. To reduce thermal capacity to achieve quicker start-ups, the base layer 101 preferably has a thickness of 100 μm or less, and more preferably has a thickness from 20 μm to 50 μm. In the present example, a cylindrical polyimide belt with a thickness of 30 μm and a diameter of 24 mm is used as the base layer 101.

The toner parting layer 104 is a layer that facilitates separation between the sheet P and toner. As the toner parting layer 104, either a PFA tube or a PFA coat may be used depending on the required thickness and mechanical and electrical strength. In the present example, a 20-μm-thick PFA tube is used as the toner parting layer 104. The toner parting layer 104 is bonded to the heat generating layer 102 with an adhesive made of silicone resin.

The heat generating layer 102 is a layer that generates Joule heat by passage of electric current therethrough. In the present example, the heat generating layer 102 is formed by applying polyimide resin paste containing carbon particles as conductive particles onto the base layer 101 in a uniform thickness. Since the total resistance value of the heat generating layer 102 is 10.0 f, power generated when a 100-V alternating-current power supply is energized is 1000 W. The resistance of the heat generating layer 102 may be appropriately determined depending on the specifications of the fixing device 40, and can be appropriately adjusted by varying the carbon content. The heat generating layer 102 may be formed in any manner as long as it has a desired resistance value. Single or composite materials other than that described above may be used to form the heat generating layer 102.

The electrode layers 105 are layers for uniform application of electric current throughout the heat generating layer 102. In the present example, the electrode layers 105 are formed on the base layer 101 along the entire circumference of the belt 100 at both ends in the longitudinal direction of the belt 100, such that the electrode layers 105 are connected to both end portions of the heat generating layer 102 in the longitudinal direction. The electrode layers 105 preferably have a resistivity sufficiently lower than that of the heat generating layer 102. In the present example, a conductive material containing silver and palladium is used to form the electrode layers 105.

The rings 119 are near-perfect circular ring-shaped members configured to stabilize the electrical connection between the belt 100 and the power feeders 80 during running of the belt 100. The rings 119 are disposed at both ends of the belt 100 in the longitudinal direction such that they are in contact with, and electrically connected to, the respective electrode layers 105 from the outside of the belt 100. In the present example, the rings 119 are each formed by pressing a 1-mm-thick copper plate. The rings 119 of the present example have an inside diameter which is substantially the same as the outside diameter of the belt 100.

The backup members 120 are each in the shape of a ring. For improved adhesion between each electrode layer 105 and the corresponding ring 119, the backup member 120 cooperates with the ring 119 to hold the belt 100 therebetween. The backup member 120 is disposed on the inner periphery of the belt 100 to face the ring 119, with the belt 100 interposed therebetween.

The backup members 120 used in the present example are each formed by pressing a 1-mm-thick copper plate. The backup members 120 of the present example have an outside diameter which is substantially the same as the inside diameter of the belt 100.

Although an adhesive made of silicone resin is used as a securing means for securing each of the rings 119 and the backup members 120 to the belt 100 in the present example, other securing means may be used. For example, the rings 119 and the backup members 120 may each be provided with tapped holes and fastened to the belt 100 with fixation screws. Thus, the electrode layers 105, the rings 119, and the backup members 120 serve as an electrode unit for receiving power supplied from the power feeders 80.

Although the rings 119 and the backup members 120 are used in the present example, they do not necessarily need to be used. If the electrode layers 105 have desired durability, the power feeders 80 and the corresponding electrode layers 105 may be brought into direct contact for electrical connection therebetween.

[Power Feeder]

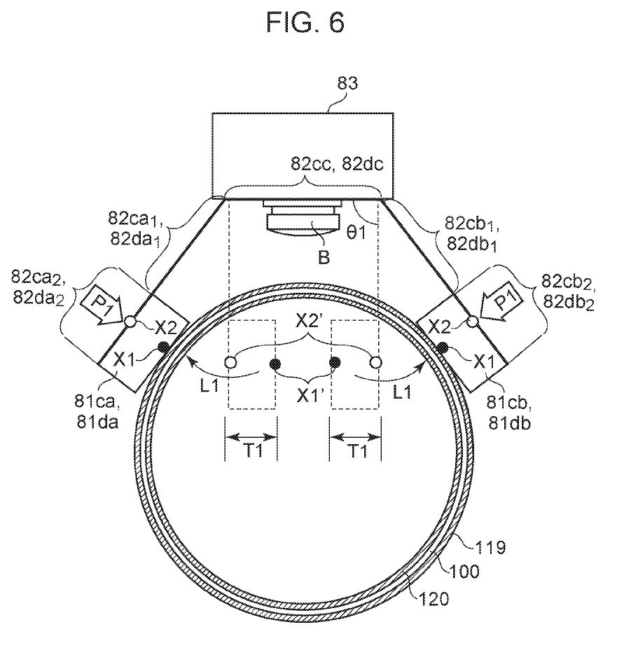

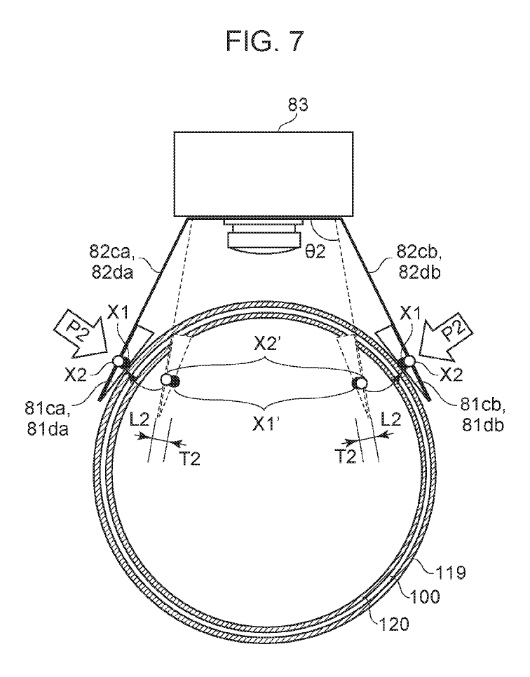

The power feeders 80 will now be described in detail. FIG. 6 illustrates a configuration of one of the power feeders 80 in an early endurance stage, and FIG. 7 illustrates a configuration of the power feeder 80 in a late endurance stage. The fixing device 40 uses the power feeders 80 to feed power to the running belt 100. For electrical connection to the rotating rings 119, the power feeders 80 include conductive brushes 81ca, 81cb, 81da, and 81db slidably in contact with the outer peripheries of the corresponding rings 119. When no distinction is needed, the brushes 81ca, 81cb, 81da, and 81db will hereinafter be referred to as brushes 81. Due to wear with use of the fixing device 40, the brushes 81 may be isolated from the corresponding rings 119 and may fail to stably come into contact with the rings 119. However, the power feeders 80 include leaf springs 82ca, 82cb, 82da, and 82db, which elastically press the corresponding brushes 81 toward the rings 119. Therefore, even when the brushes 81 are in an advanced stage of wear, the brushes 81 can be electrically connected to the belt 100. When no distinction is needed, the leaf springs 82ca, 82cb, 82da, and 82db will hereinafter be referred to as leaf springs 82. Particularly in the present example, the deflection of each leaf spring 82 is adjusted to allow the brushes 81 to be used as long as possible. Specifically, the fixing device 40 is designed such that if the leaf springs 82 are in a natural state, a region of each brush 81 that can come into contact with the ring 119 is located within a region surrounded by the outer periphery of the ring 119. Note that the natural state of the leaf spring 82 refers to a hypothetical state where the power feeder 80 is not in contact with the ring 119 and the leaf spring 82 produces no elastic force. The power feeder 80 will now be described in detail using drawings.

As illustrated in see FIG. 3, the power feeders 80 are electrically connected to the power supply circuit 79, and brought into contact with the respective rings 119 to feed power to the belt 100. The power feeder 80c on the left side of the belt 100 in the longitudinal direction includes the leaf springs 82ca and 82cb and the brushes 81ca and 81cb. The power feeder 80d on the right side of the belt 100 in the longitudinal direction includes the leaf springs 82da and 82db and the brushes 81da and 81db.

The brushes 81 are each a slidable conductive contact pad in contact with the ring 119. For example, a graphite member (carbon brush) having high slidability and conductivity can be used as the brush 81. The brush 81 may contain a lubricant to reduce friction with the ring 119. If the brush 81 contains a lubricant, the stiffness of the brush 81 may be degraded and this may result in advanced wear. However, the improved slidability between the brush 81 and the ring 119 can stabilize the electrical connection between the brush 81 and the ring 119. The brushes 81 of the present example are blocks which are in the shape of a rectangular parallelepiped and made of a metal graphite material formed by mixing carbon, silver, and copper. The brushes 81 are each 10 mm long in the circumference direction of the belt 100, 5 mm long in the width direction of the belt 100, and 5 mm thick.

The leaf springs 82 are each an elastic member (pressing member or biasing means) configured to press the corresponding brush 81 against the outer periphery of the ring 119 with the elastic force thereof. Also, the leaf springs 82 are each a power feed path for electrically connecting the corresponding brush 81 to the power supply circuit 79. In this case, the power supply circuit 79 and the leaf springs 82 serve as a power feed means electrically connecting to the brushes 81 to feed power to the heat generating layer 102.

The leaf spring 82ca (see FIG. 2) is a rectangular member made of stainless steel or the like having conductivity and elasticity. The leaf spring 82ca is secured at one end thereof to a supporting member 83c, and joined at the other end thereof to the brush 81ca with a conductive adhesive or the like. The leaf spring 82ca has, as illustrated in FIG. 6, a metal-plate portion 82ca₂ joined to the brush 81ca, and an extending portion (spring portion) 82ca₁ extending outward from the brush 81ca and secured to a supporting member 83. That is, the leaf spring 82ca has the metal-plate portion 82ca₂ and the extending portion 82ca₁ integral therewith. Similarly, the leaf spring 82cb has a metal-plate portion 82cb₂ and an extending portion 82cb₁ integral therewith. The leaf spring 82da has a metal-plate portion 82da₂ and an extending portion 82da₁ integral therewith. The leaf spring 82db has a metal-plate portion 82db₂ and an extending portion 82db₁ integral therewith.

The leaf springs 82ca and 82cb of the present example are formed by pressing a stainless plate which is 75 mm long in the longitudinal direction, 5 mm wide, and 0.2 mm thick into a U-shape. Then, one end of the stainless plate is used as the leaf spring 82ca and the other end of the stainless plate is used as the leaf spring 82cb. A center portion of the stainless plate in the longitudinal direction is used as a fixed plate 82cc, which is secured with a screw B to the supporting member 83c. The fixed plate 82cc is electrically connected through a wire (not shown) to the power supply circuit 79. The leaf springs 82ca and 82cb and the fixed plate 82cc are each 25 mm long in the longitudinal direction. Similarly, the leaf springs 82da and 82db of the present example are formed by pressing a stainless plate into a U-shape. Then, one end of the stainless plate is used as the leaf spring 82da and the other end of the stainless plate is used as the leaf spring 82db. A center portion of the stainless plate in the longitudinal direction is used as a fixed plate 82dc, which is secured with the screw B to the supporting member 83d. The fixed plate 82dc is electrically connected through a wire (not shown) to the power supply circuit 79. The leaf springs 82da and 82db and the fixed plate 82dc are each 25 mm long in the longitudinal direction.

In the present example, the leaf springs 82 are each used not only as a power feed path electrically connected to the corresponding brush 81, but also as a biasing means for biasing the brush 81 toward the corresponding ring 119. The configuration of each power feeder 80 is not limited to this. For example, the power feeder 80 may include a lead wire (not shown) electrically connecting the brush 81 to the power supply circuit 79, and an insulating leaf spring (not shown) configured to bias the brush 81 toward the ring 119.

The power feeder 80c of the present example includes two leaf springs (82ca and 82cb) and two brushes (81ca and 81cb) to stabilize the feeding of power to the ring 119c. However, the configuration of the power feeder 80c is not limited to this. For example, a configuration including only one leaf spring (82ca) and one brush (81ca) is sufficiently practical. The same applies to the power feeder 80d.

As illustrated in FIG. 6, when θ1 is 90°, the leaf springs 82ca and 82cb unused after manufacture (i.e., in the early endurance stage) are in the natural state where no elastic force (spring load) is exerted. Then, when the ring 119 is placed to press the two brushes 81ca and 81cb apart, the leaf springs 82ca and 82cb deflect by L1 to produce an elastic force. In the present example, the ring 119 is positioned such that the distance between the base of each of the brushes 81ca and 81cb and the center of the diameter of the ring 119 is 40 mm. In other words, the ring 119 is positioned such that the shortest distance between the fixed plate 82cc and the ring 119 is 8 mm. Then, the leaf springs 82ca and 82cb bias the brushes 81ca and 81cb toward the outer periphery of the ring 119 with a spring load P1. The spring load P1 in the present example is 100 gf. The travel distance of the brushes 81ca and 81cb corresponding to the deflection L1 is greater than a thickness T1 of the brushes 81ca and 81cb. Therefore, regardless of the thickness of the brushes 81ca and 81cb, the leaf springs 82ca and 82cb can press the brushes 81ca and 81cb against the ring 119.

In a surface region of each brush 81 in contact with the ring 119, a center portion in the circumference direction of the belt 100 is a point X1. In a surface opposite the contact surface of the brush 81 in contact with the ring 119 (i.e., in a surface of the brush 81 bonded to the leaf spring 82), a portion opposite the point X1 is a point X2. Portions corresponding to the points X1 and X2 of the brush 81 when the leaf spring 82 is in the natural state are referred to as points X1′ and X2′, respectively. The points X1′ and X2′ are preferably located inside (or at positions overlapping) the region surrounded by the outer periphery of the ring 119. In this case, the leaf spring 82 can press the brush 81 against the ring 119 regardless of the thickness of the brush 81. More preferably, if the leaf spring 82 is in the natural state, the entire brush 81 is located inside (or at a position overlapping) the region surrounded by the outer periphery of the ring 119. In this case, the fixing device 40 can allow the brush 81 to be used until it is completely worn out.

When the brush 81 is brought into direct contact with the electrode layer 105 without using the ring 119, it is preferable that the points X1′ and X2′ or the entire brush 81 be located inside (or overlap) the region surrounded by the outer periphery of the electrode layer 105.

As described above, the brush 81 wears because it is pressed and slid against the rotating ring 119 over a long time under the spring load of the leaf spring 82. As a result, the thickness of the brush 81 decreases from the early endurance stage (see FIG. 6) to the late endurance stage (see FIG. 7). A thickness T2 of the brush 81 in the late endurance stage is, for example, 1 mm. The leaf spring 82 may be plastically deformed by pressing the brush 81 against the ring 119 over a long time. That is, the angle of the leaf spring 82 at the base thereof may be increased from θ1 (90°) in the early endurance stage to θ2 (e.g., 92°) in the late endurance stage. However, in the present example, even in the late endurance stage, the travel distance of the brush 81 corresponding to a deflection L2 is greater than the thickness T2 of the brush 81. The leaf spring 82 can bias the brush 81 toward the ring 119 with a sufficient strength. In the present example, a spring load P2 in the late endurance stage is 50 gf. Therefore, regardless of the thickness of the brush 81, the leaf spring 82 can press the brush 81 against the ring 119.

If the leaf spring 82 in the late endurance stage is in the natural state, the points X1′ and X2′ of the brush 81 are preferably located inside (or at positions overlapping) the region surrounded by the outer periphery of the ring 119. In this case, even in the late endurance stage, the leaf spring 82 can press the brush 81 against the ring 119 regardless of the thickness of the brush 81. More preferably, if the leaf spring 82 in the late endurance stage is in the natural state, the entire brush 81 is located inside (or at a position overlapping) the region surrounded by the outer periphery of the ring 119. In this case, the fixing device 40 can allow the brush 81 to be used until it is completely worn out, even if the leaf spring 82 is plastically deformed.

When the brush 81 is brought into direct contact with the electrode layer 105 without using the ring 119, it is preferable that the points X1′ and X2′ or the entire brush 81 be located inside (or overlap) the region surrounded by the outer periphery of the electrode layer 105.

When the brushes 81 are used up (worn out), no brushes 81 are present between the leaf springs 82 and the ring 119. In this case, the ring 119 and the leaf springs 82 come into direct contact. In the present example, as described above, the leaf springs 82 are conductive members each serving as a power feed path for electrically connecting the corresponding brush 81 to the power supply circuit 79. Therefore, even when there are no brushes 81 between the leaf springs 82 and the ring 119, the fixing device 40 can feed power to the belt 100. That is, a sudden interruption of the electrical connection between the belt 100 and the power supply circuit 79 can be avoided even when the brushes 81 are in an advanced stage of wear. However, for stable power feeding, it is preferable that there be the brushes 81 between the ring 119 and the leaf springs 82. Therefore, the direct contact between the ring 119 and the leaf springs 82 is preferably detected. The direct contact between the ring 119 and each leaf spring 82 may be detected, for example, by using a sensor (not shown) that detects the angle of the leaf spring 82. Then, if the angle of the leaf spring 82 becomes smaller than a predetermined value (e.g., 100°), the sensor may send a message that prompts replacement of the power feeder 80. That is, the fixing device 40 can detect the life of each brush 81 and safely stop the fixing operation. With the configuration described above, it is possible to avoid a sudden interruption of power feeding from the power supply circuit 79 to the belt 100 caused by advanced wear of the brushes 81. Therefore, it is unlikely that the temperature of the belt 100 will suddenly drop and that an unfixed toner image T will be discharged to the outside of the printer 1.

In the present example, by allowing each leaf spring 82 to sufficiently deflect, the corresponding brush 81 can be used until it is completely worn out. Also in the present example, the leaf spring 82 electrically connected to the power supply circuit 79 is joined to a surface opposite the contact surface of the brush 81 in contact with the ring 119. Therefore, even when the brush 81 is worn out, it is still possible to continue to feed power from the power feeder 80 to the belt 100.

### (Other Examples)

Although examples to which the present invention is applicable have been described, numerical values (e.g., dimensions) described in Examples are merely illustrative and not restrictive. Numerical values can be appropriately selected within the scope of the present invention. The configurations described in Examples can be appropriately changed within the scope of the present invention.

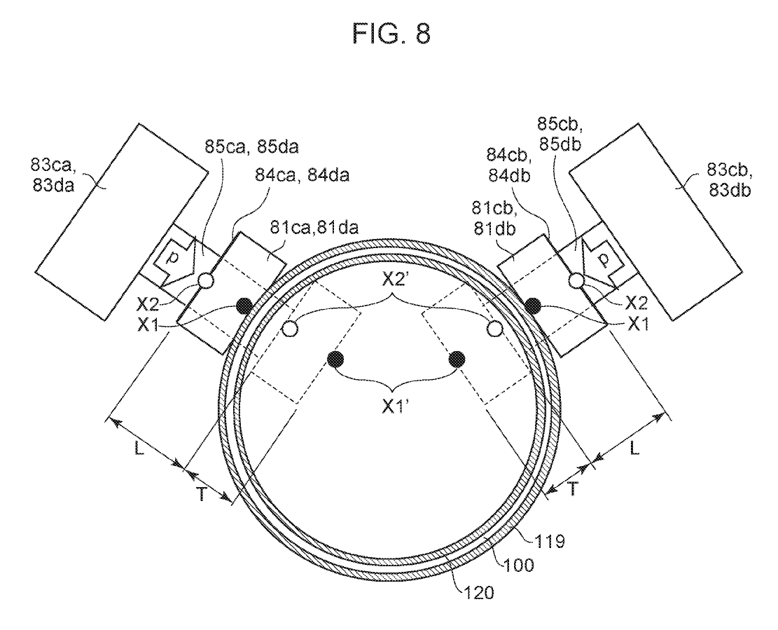

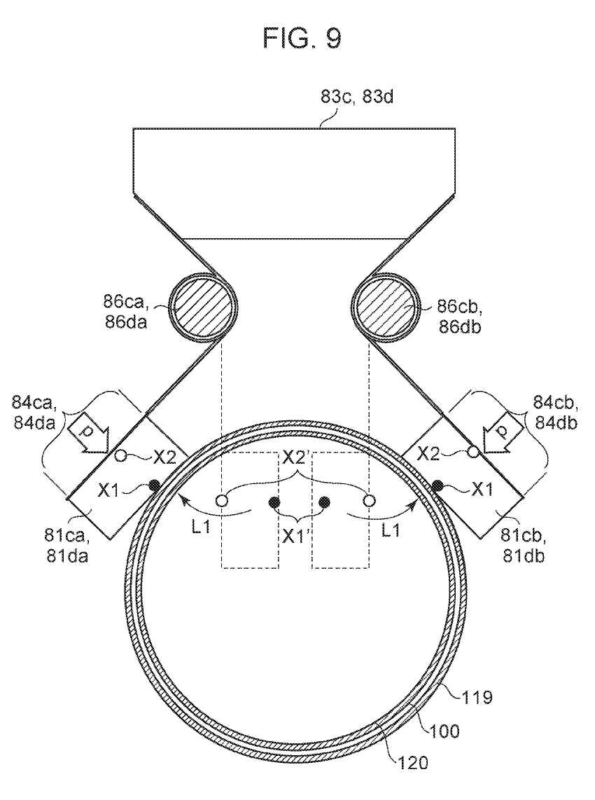

In Examples described above, the leaf spring 82 made of metal having conductivity and elasticity is used as an elastic member that biases the brush 81 toward the ring 119. However, the configuration of the power feeder 80 is not limited to this. FIG. 8 illustrates a configuration of the power feeder 80 according to another example, and FIG. 9 illustrates a configuration of the power feeder 80 according to still another example. For example, as illustrated in FIG. 8, a linear compression spring made of metal having conductivity and elasticity may be used as the elastic member (biasing means). This configuration is more preferable than that in Examples described above in that the compression spring is not easily plastically deformed, and that a pressure “p” applied to the brush 81 can be greater. Specifically, a metal plate 84ca (84cb, 84da, or 84db) is joined to a surface of the brush 81ca (81cb, 81da, or 81db) facing the metal plate 84ca (84cb, 84da, or 84db). Then, a compression spring 85ca (85cb, 85da, or 85db) in a compressed state is positioned between the metal plate 84ca (84cb, 84da, or 84db) and a supporting member 83ca (83cb, 83da, or 83db). A conductive rubber member made of resin having conductivity and elasticity may be used as the elastic member (biasing means), as long as it has the same function as the compression spring 85ca (85cb, 85da, or 85db) made of metal. Alternatively, as illustrated in FIG. 9, a linear torsion coil spring having conductivity and elasticity may be used as the elastic member (biasing means). This configuration is more preferable than that in Examples described above in that the torsion coil spring is not easily plastically deformed, and that a pressure “p” applied to the brush 81 can be greater. Specifically, the metal plate 84ca (84cb, 84da, or 84db) is joined to a surface of the brush 81ca (81cb, 81da, or 81db) facing the metal plate 84ca (84cb, 84da, or 84db). Then, a torsion coil spring 86ca (86cb, 86da, or 86db) deflected at a predetermined torsion angle may be positioned between the metal plate 84ca (84cb, 84da, or 84db) and the supporting member 83c (83d). Even with the configurations described above, it is still possible to use the brush 81 until it is completely worn out, as long as the points X1′ and X2′ or the entire brush 81 are/is located inside (or overlap/overlaps) a region surrounded by the outer periphery of the ring 119 when the elastic member is in the natural state. It is preferable, however, to use the configuration described in Examples in that the configuration of the power feeder 80 can be simplified.

A component that cooperates with the belt 100 to form the nip portion N therebetween is not limited to a roller member, such as the roller 110. For example, a pressure belt unit formed by stretching a belt over a plurality of rollers may be used.

A method for rotationally driving the belt 100 is not limited to transmitting the drive from the roller 110 to the belt 100. For example, the belt 100 may be provided with a gear, which directly rotationally drives the belt 100. However, the configuration described in Examples is preferable in that the thermal capacity of the belt 100 can be reduced.

The image forming apparatus described using the printer 1 as an example is not limited to an image forming apparatus that forms full color images, but may be an image forming apparatus that forms black-and-white images. By addition of necessary devices and equipment along with a housing structure, the image forming apparatus can be implemented as a copier, a facsimile machine, or a multifunction peripheral combining some of these functions, for various applications.

The image heating device described above is not limited to a fixing device that fixes an unfixed toner image T onto the sheet P. For example, the image heating device may be a device that fixes a fixed toner image on the sheet P, or may be a device that performs a heating process on a fixed image. Therefore, the image heating device may be used as a surface heating device that adjusts the glossiness and surface nature of an image.

The present invention can provide an image heating device in which the occurrence of a failure in feeding power to the belt can be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image heating device comprising:
an endless belt including a heat generating layer that generates heat when energized, the belt being configured to heat an image on a sheet;
a driving unit configured to rotationally drive the belt;
a first ring-shaped member disposed at one end of the belt in a longitudinal direction and extending along an outer periphery of the belt, the first ring-shaped member being electrically connected to the heat generating layer;
a first contact pad configured to be brought into contact with an outer periphery of the first ring-shaped member and electrically connected to the first ring-shaped member;
a power supply unit configured to feed power to the first contact pad; and
a first pressing member disposed to face the first ring-shaped member with the first contact pad interposed therebetween, the first pressing member being configured to elastically press the first contact pad toward the first ring-shaped member regardless of the amount of wear of the first contact pad.

2. The image heating device according to claim 1, wherein the first pressing member elastically presses the first contact pad toward the first ring-shaped member such that when the first pressing member is in a natural state, an entire area of the first contact pad overlaps a region surrounded by the first ring-shaped member.

3. The image heating device according to claim 1, wherein the first pressing member is electrically connected to the first contact pad, and the power supply unit feeds power through the first pressing member to the first contact pad; and
when the first contact pad wears by a predetermined amount, the first pressing member comes into contact with and electrically connects to the first ring-shaped member.

4. The image heating device according to claim 3, wherein the first pressing member is a leaf spring.

5. The image heating device according to claim 1, wherein the first contact pad is a carbon brush.

6. The image heating device according to claim 5, wherein the first contact pad contains a lubricant.

7. The image heating device according to claim 1, wherein the driving unit is a pressure roller configured to come into contact with the belt to form a nip portion between the belt and the pressure roller, and the pressure roller rotationally drives the belt and conveys the sheet while holding the sheet at the nip portion.

8. The image heating device according to claim 1, further comprising:
a second ring-shaped member disposed at the other end of the belt in the longitudinal direction and extending along the outer periphery of the belt, the second ring-shaped member being electrically connected to the heat generating layer;
a second contact pad configured to be brought into contact with an outer periphery of the second ring-shaped member and electrically connected to the second ring-shaped member, the second contact pad being fed with power from the power supply unit; and
a second pressing member disposed to face the second ring-shaped member with the second contact pad interposed therebetween, the second pressing member being configured to elastically press the second contact pad toward the second ring-shaped member regardless of the amount of wear of the second contact pad.

9. An image heating device comprising:
an endless belt configured to heat an image on a sheet, the belt including a heat generating layer configured to generate heat when energized and a first electrode layer disposed at one end of the belt in a longitudinal direction and electrically connected to the heat generating layer;
a driving unit configured to rotationally drive the belt;
a first contact pad configured to be brought into contact with an outer periphery of the first electrode layer and electrically connected to the first electrode layer;
a power supply unit configured to feed power to the first contact pad; and
a first pressing member disposed to face the first electrode layer with the first contact pad interposed therebetween, the first pressing member being configured to elastically press the first contact pad toward the first electrode layer regardless of the amount of wear of the first contact pad.

10. The image heating device according to claim 9, wherein the first pressing member elastically presses the first contact pad toward the first electrode layer such that when the first pressing member is in a natural state, an entire area of the first contact pad overlaps a region surrounded by the first electrode layer.

11. The image heating device according to claim 9, wherein the first pressing member is electrically connected to the first contact pad, and the power supply unit feeds power through the first pressing member to the first contact pad; and
when the first contact pad wears by a predetermined amount, the first pressing member comes into contact with and electrically connects to the first electrode layer.

12. The image heating device according to claim 10, wherein the first pressing member is a leaf spring.

13. The image heating device according to claim 9, wherein the first contact pad is a carbon brush.

14. The image heating device according to claim 12, wherein the first contact pad contains a lubricant.

15. The image heating device according to claim 9, wherein the driving unit is a pressure roller configured to come into contact with the belt to form a nip portion between the belt and the pressure roller, and the pressure roller rotationally drives the belt and conveys the sheet while holding the sheet at the nip portion.

16. The image heating device according to claim 9, further comprising:
a second electrode layer disposed at the other end of the belt in the longitudinal direction and electrically connected to the heat generating layer;
a second contact pad configured to be brought into contact with an outer periphery of the second electrode layer and electrically connected to the second electrode layer, the second contact pad being fed with power from the power supply unit; and
a second pressing member disposed to face the second electrode layer with the second contact pad interposed therebetween, the second pressing member being configured to elastically press the second contact pad toward the second electrode layer regardless of the amount of wear of the second contact pad.
